(19) United States
(12) Patent Application Publication
(10) Pub. No.: US 2016/0372866 A1
(43) Pub. Date: Dec. 22, 2016

(54) CONNECTOR

(71) Applicant: YAZAKI CORPORATION, Tokyo (JP)

(72) Inventor: Tetsuya SEKINO, Shizuoka (JP)

(73) Assignee: YAZAKI CORPORATION, Tokyo (JP)

(21) Appl. No.: 15/249,576

(22) Filed: Aug. 29, 2016

Related U.S. Application Data
(63) Continuation of application No. PCT/JP2015/056971, filed on Mar. 10, 2015.

(30) Foreign Application Priority Data
Mar. 26, 2014 (JP) 2014-063749

(51) Int. Cl. H01R 13/631; H01R 13/641

(52) U.S. Cl. CPC H01R 13/631; H01R 13/641

(57) ABSTRACT

This connector is provided with a male connector part (10) including male terminals (11), and a female connector part including female terminals. The male connector pan (10) and a second connector part are fitted together in a fixed fitting direction, and the male terminals (11) and the female terminals are connected. At least one of the outer peripheral surfaces (12a, 23a) of the male connector part (10) and the female connector part has, provided thereto, a plurality of front-alignment indicators (16a, 16b, 16c, 26a, 26b, 26c) which have an appearance that changes in accordance with the rotational angle of the viewing direction. At least one of the front-alignment indicators (16a, 16b 16c, 26a, 26b, 26c) can be seen in cases in which the at least one of the outer peripheral surfaces (12a, 23a) is viewed from a direction at rotational angle.

### CROSS REFERENCE TO RELATED APPLICATIONS

This application is a Continuation of PCT Application No. PCT/IP2015/056971, filed on Mar. 10, 2015, and claims the priority of Japanese Patent Application No. 2014-063749, filed on Mar. 26, 2014, the content of both of which is incorporated herein by reference.

### BACKGROUND

Technical Field

The present invention relates to a connector for achieving electrical connection by fitting two connector parts with each other.

Related Art

For example, the connector consists of a first connector part having a first terminal and a second connector part having a second terminal. During fitting of the connector, since connections axe allowed only between the first and second terminals corresponding to each other, they are configured to be finable in only a prescribed fitting direction (see JP 10-3963 A and PP 2001-6802 A). Therefore, the worker is required to perform the fitting operation by viewing both the front shapes (terminal arrangement patterns) of the first connector part and the second connector part.

Meanwhile, as shown in FIG. 6, regarding the first connector part 50 to be fixed to a mounting portion 60 by screwing, the front orientation of the first connector part 50 is not constant. Moreover, there are cases where the periphery of the first connector part 50 may include a structure 61 for example, and thus the worker cannot visually recognize the opening orientation of the first connector part 50 from above, or may have difficulty of recognizing.

### SUMMARY OF THE INVENTION

Therefore, conventionally, in situations where there is a problem in the visibility of the front shape of the first connector part or the second connector part, there have been problems that fitting operations cannot be performed easily.

Accordingly, the present invention has been made to solve the problems described above, and an object thereof is to provide a connector which can allow easy fitting operations without visually recognizing the front shapes.

A first aspect according to the present invention is a connector including a first connector part having a first terminal. a second connector part being fitted to the first connector part in a prescribed fitting orientation and having a second terminal to be connected to the first terminal, and a plurality of front-alignment indicators provided on an outer peripheral surface of at least one of the first connector part and the second connector part such that at least one of the plurality of front-alignment indicators is visible even when the outer peripheral surface is viewed from any rotational angle direction and appearances of the plurality of front-alignment indicators change when a rotational angle direction from which the outer peripheral surface is viewed changes.

The plurality of front-alignment indicators may be provided at three or more positions, and all of the front-alignment indicators may be arranged in a region smaller than half the outer peripheral surface in a circumferential direction, and the front-alignment indicators located at both ends of the region in which the front-alignment indicators are arranged may be protrusions. The plurality of front-alignment indicators may be provided on both outer peripheral surfaces of the first connector part and the second connector part and the plurality of front-alignment indicators provided on both outer peripheral surfaces of the first connector part and the second connector part may be provided at same rotational positions with respect to a front orientation. Two front-alignment indicators located at both ends may have protrusion heights such that both of the two front-alignment indicators are visible when viewed from a rotational angle direction opposite to a rotational angle direction from which all the front-alignment indicators can be seen to be located symmetrically.

According to the present invention, since the front orientation can be recognized by the appearance of front-alignment indicators, the fitting between the connector parts can be performed easily without viewing the front shapes.

### BRIEF DESCRIPTION OF DRAWINGS

FIG. 1 is a front view illustrating an installation state of a male connector part according to an embodiment of the present invention;

FIG. 2 is an exploded perspective view illustrating a connector according to the embodiment of the present invention;

FIG. 3A is a view illustrating a rear view of the male connector part according to the embodiment of the present invention;

FIG. 3B is a view illustrating a left side view of the male connector part according to the embodiment of the present invention;

FIG. 3C is a view illustrating a front view of the male connector part according to the embodiment of the present invention;

FIG. 3D is a view illustrating a right side view of the male connector part according to the embodiment of the present invention;

FIG. 3E is a view illustrating a plan view of the male connector part according to the embodiment of the present invention

FIG. 4A is a view illustrating a rear view of a female connector part according to the embodiment of the present invention;

FIG. 4B is a view illustrating a left side view of the female connector part according to the embodiment of the present invention;

FIG. 4C is a view illustrating a front view of the female connector part according to the embodiment of the present invention;

FIG. 4D is a view illustrating a right side view of the female connector part according to the embodiment of the present invention;

FIG. 4E is a view illustrating a plan view of the female connector part according to the embodiment of the present invention;

FIG. 5A is a view illustrating a front view of a male connector part according to a first variation;

FIG. 5B is a view illustrating a front view of a male connector part according to a second variation;

FIG. 5C is a view illustrating a cross-sectional view of a male connector part according to a third variation; and

FIG. 6 is a view illustrating an installation state of a first connector part according to a conventional example.

### DETAILED DESCRIPTION

Hereinafter, an embodiment of the present invention will be described based on the drawings.

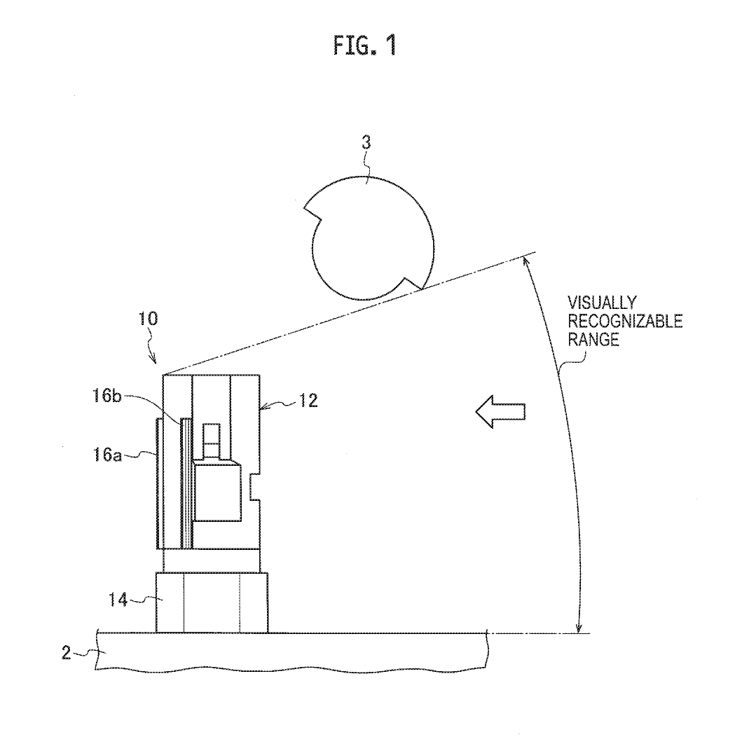

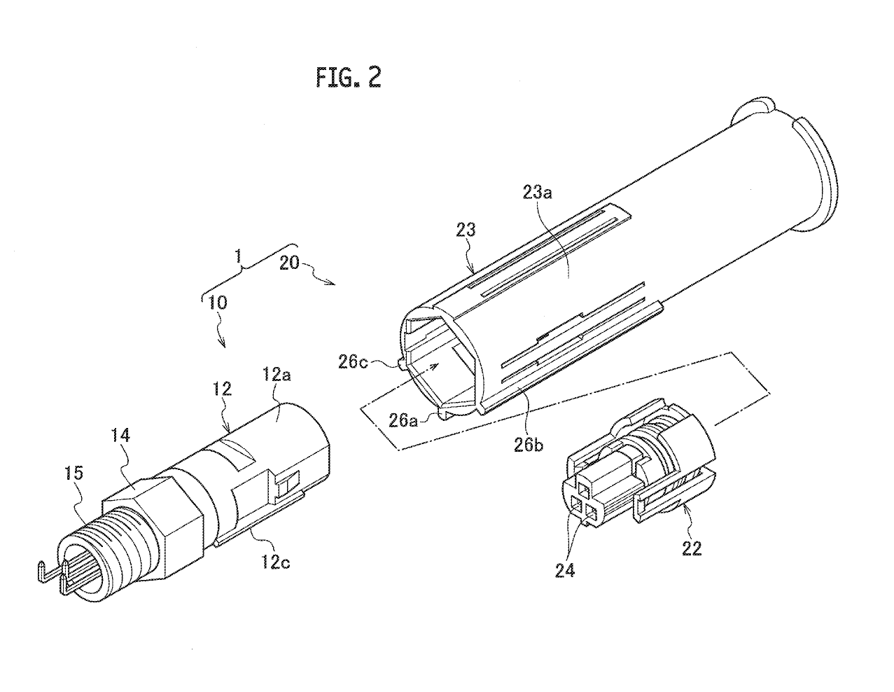

FIGS. 1 to 4E illustrate an embodiment of the present invention. As shown in FIG. 2, a connector 1 consists of a male connector part 10 as a first connector part and a female connector part 20 as a second connector part.

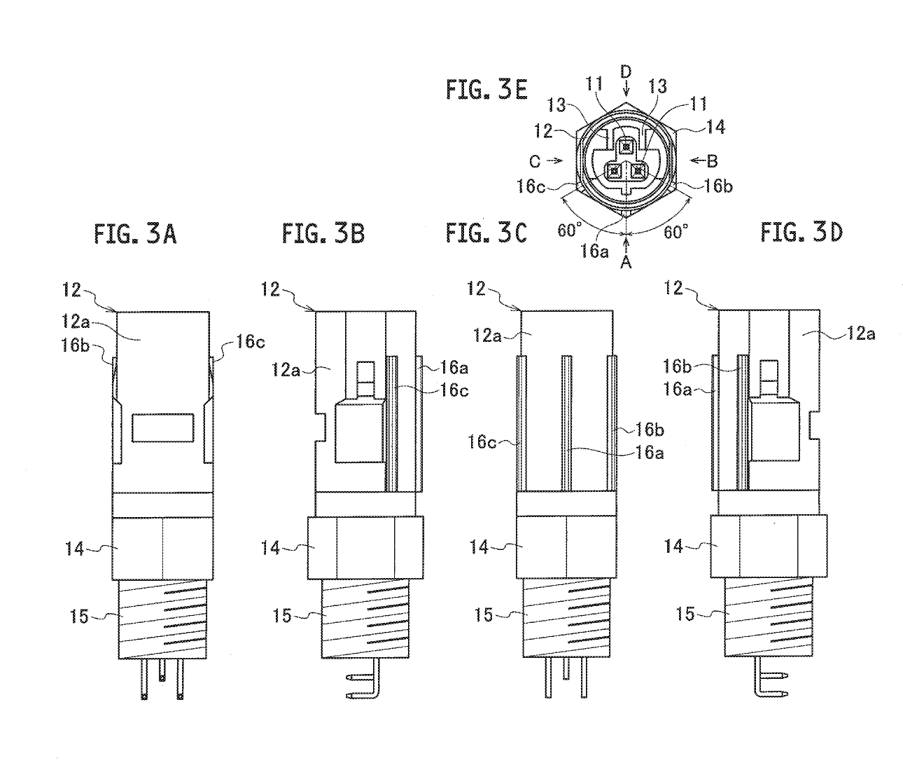

The male connector part 10, as shown in FIGS. 2 and 3E, has male terminals 11 as a plurality (three) of first terminals and a male housing 12 in which the male terminals 11 are arranged. The male housing 12 is in a substantially cylindrical shape, and the upper surface has an opening. The male terminals 11 are housed in the opening. On the inner surface of the male housing 12, ribs 13 for allowing the fitting of the normal orientation of the female connector 20 and preventing the fitting of non-normal orientation are provided. A fixing nut portion 14 and a threaded portion 15 are provided on the lower side of the male housing 12.

The outer peripheral surface 12a of the male housing 12 is substantially formed as a circular circumferential surface. On this male housing outer peripheral surface 12a, as shown in FIGS. 3A to 3E, a plurality of male connector front-alignment indicators 16a, 16b and 16c are provided such that at least one of them can be visually recognized in the case of viewing the outer peripheral surface 12a from any direction of the rotational angle, and the appearances of them changes when the viewing direction of the rotational angle changes. The plurality of front-alignment indicators 16a, 16b and 16c are arranged at three positions within a region smaller than half the area of the outer peripheral surface 12a in the circumferential direction. The front-alignment indicators 16a, 16b and 16c at the three positions are arranged at 60 degree angle intervals around the center of rotation. In this embodiment, the three from-alignment indicators 16a, 16b and 16c are arranged within the region of the outer peripheral surface 12a corresponding to the range of a rotational angle of 120 degrees. The front-alignment indicators 16a, 16b and 16c at the three positions are an elongated protrusions extending in the axial direction of a cylindrical shape of the male housing 12. All three are protrusions of the same length. Two front-alignment indicators 16b and 16c located at both ends have protrusion heights such that both of them are visible when seen from the rotational angle direction (rear view described below) opposite to the rotational angle direction from which all the front-alignment indicators 16a, 16b and 16c can be seen to be located symmetrically (front view described below).

In the male housing 12, when the orientation in FIG. 3C is defined as the front for convenience, the front-alignment indicators 16a, 16b and 16c have appearances as follows.

In the front view (arrow A direction), three front-alignment indicators 16a, 16b and 16c can be visually recognized at bilaterally symmetric positions. In the right side view (arrow B direction), two front-alignment indicators 16a and 16b are visible at positions deflected to the left side. In the left side view (arrow C direction), two front-alignment indicators 16a and 16c are visible at positions deflected to the right side. In the rear view (arrow D direction), two front-alignment indicators 16b and 16c which protrudes from the left and right ends of the male housing 12 are visible. Thus at least one of them is visible when the outer peripheral surface 12a is viewed from any rotational angle direction, and the appearance changes when the rotational angle direction of the viewing changes.

As shown in FIG. 1, the male connector part 10 is installed by screwing and fixing the threaded portion 15 to the mounting portion 2. The male connector part 10 is fixed by a screw fixation, and thus not fixed in a constant orientation.

The female connector part 20 is provided with female terminals (not shown) consisting of a plurality (three) of second terminals, an inner housing 22 in which these female terminals are arranged and an exterior housing 23 which houses the inner housing 22. On the lower surface of the inner housing 22, openings 24 which the male terminals 11 enter (shown in FIG. 2) are formed. Between the outer periphery of the inner housing 22 and the inner peripheral surface of the exterior housing 23, a gap (not shown) which the male housing 12 enters is formed.

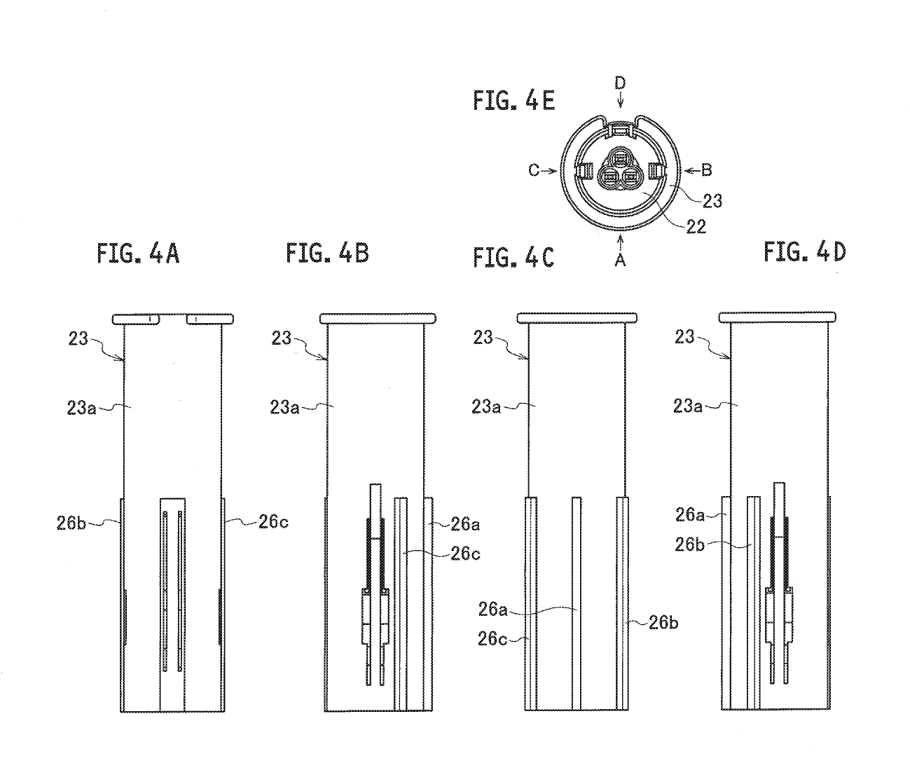

The exterior housing 23 is cylindrical in shape and an exterior housing outer peripheral surface 23a is a circular circumferential surface. The outer peripheral surface 23a, similarly to the male housing 12 as shown in FIGS. 4A to 4E, has a plurality of female connector front-alignment indicators 26a, 26b and 26c, at least one of which is visible when the outer peripheral surface 23a is viewed from any rotational angle direction and whose appearances change when the rotational angle direction of the viewing changes. The plurality of front-alignment indicators 26a, 26b and 26c are arranged at three positions in a region smaller than half the area of the outer peripheral surface 23a in the circumferential direction. The front-alignment indicators 26a, 26b and 26c at three positions are arranged at the positions at 60 degree intervals of the angle around the center of rotation. In this embodiment, the three front-alignment indicators 26a, 26b and 26c are arranged in the region of the outer peripheral surface 23a corresponding to the range of the rotational angle of 120 degrees. The front-alignment indicators 26a, 26b and 26c at the three positions are elongated protrusions extending in the axial direction of the cylindrical shape of the exterior housing 23. All the protrusions at the three positions are of the same length. Two front-alignment indicators 26b and 26c located at both ends have protrusion heights such that both of the indicators are visible when seen from the rotational angle direction (rear view described below) opposite to the rotational angle direction from which all the front-alignment indicators 26a, 26b and 26c are seen to be located symmetrically (front view described below).

In the exterior housing 23, when the orientation of FIG. 4C is defined as the front for the sake of convenience, the female connector front-alignment indicators 26a, 26b and 26c are provided at the same rotational positions as the male housing outer peripheral surface 12a of the male connector part 10 with respect to the front orientation. Therefore, the female connector front-alignment indicators 26a, 26b and 26c of the female connector part 20 have appearances of the same pattern as the male housing 12. Then, the front orientations of the male connector part 10 and the female connector part 20 accord with each other by aligning the mutual front-alignment indicators 16a, 16b, 16c, 26a, 26b and 26c to each other.

In the above configuration, as for the installation situation of the male connector part 10, there is a structure 3 around the male connector part 10 as shown in FIG. 1. Therefore, the range which can be visually recognized by the operator is limited and the front shape of the male connector part 10 cannot be visually recognized, or is recognized with difficulty.

The outer peripheral surface 12a of the male housing 12 is provided with the male connector front-alignment indicators 16a, 16b and 16c, at least one of which is visible when the male housing outer peripheral surface 12a is viewed from any rotational angle direction, and whose appearances change when the rotational angle direction of the viewing changes. The worker can recognize the front orientation without viewing the front shape and with viewing only the male housing outer peripheral surface 12a, by previously recognizing the relationship between the appearance pattern of the male connector front-alignment indicators 16a, 16b and 16c of the male housing 12 and the front orientation. The fore, the female connector part 20 can be easily fitted with the male connector part 10.

Although it is sufficient that only the male connector front-alignment indicators 16a, 16b and 16c may be provided to the male connector part 10 having an invisible front shape or poor visibility of the front shape, the female connector front-alignment indicators 26a, 26b and 26e are provided to the exterior housing outer peripheral surface 23a of the female connector part 20 in addition in this embodiment. Therefore, the front orientation of the female connector part 20 can be recognized by viewing only the exterior housing outer peripheral surface 23a without actually viewing the front orientation of the female connector part 20.

Moreover, in this embodiment, the front-alignment indicators 16a, 16b, 16c, 26a, 26b and 26c of both the male connector part 10 and the female connector part 20 are provided at the same rotational positions therebetween relative to the front orientation. Therefore, by aligning the mutual front-alignment indicators 16a, 16b, 16c, 26a, 26b and 26c to each other, the front orientations agree with each other and the female connector part 20 can be fined more easily with the male connector part 10. That is, as in this embodiment, by providing the front-alignment indicators 16a, 16b, 16c, 26a, 26b and 6c to both the male connector part 10 and the female connector part 20, actual viewing of the front shape becomes unnecessary, and moreover, the female connector part 20 can be easily fitted with the male connector part 10 without taking into consideration the relationship between the appearance pattern of the front-alignment indicators 16a, 16b, 16c, 26a, 26b and 26c and the front orientation.

The plurality of front-alignment indicators 16a, 16b, 16c, 26a, 26b and 26e are provided in three or more positions on each part, and the front-alignment indicators 16b, 16c, 26b and 26c on both sides are protrusions, and then all the front-alignment indicators 16a, 16b, 16c, 26a, 26b and 26c are arranged in a region smaller than half of each of the outer peripheral surfaces 12a and 23a in the circumferential direction. Since the front-alignment indicators 16b, 16c, 26b and 26c on both sides are protrusions, the range where the indicators are visible from the surroundings is increased and the installation space of the plurality of front-alignment indicators 16a, 16b, 16c, 26a, 26b and 26c can be as small as possible. Then, the space used for other objects can be widen on the outer peripheral surfaces 12a and 23a. Since the front-alignment indicators 16a, 16b, 16e, 26a, 26b and 26c are located at three positions on each. part, the difference in appearance depending on the rotational angle direction is simple, and thus, the recognizability is improved. Incidentally, the indicators may also be provided at four or more positions as a matter of course.

Two of the front-alignment indicators 16b, 16e, 26b and 26c located at both ends have protrusion heights such that both of the indicators may be visible when viewed from the rotational angle direction (rear view described below) opposite to the rotational angle direction (front view described below) from which all the front-alignment indicators 16a, 16b, 16c, 26a, 26b and 26c can be seen to be located symmetrically. Thus, two of the front-alignment indicators 16b, 16c, 26b and 26c can be seen at the right and left ends of each of the outer peripheral surfaces 12a and 23a in the rear view. In this appearance, the central front-alignment indicators 16a and 26a are missing differently from the appearance in the front view and it becomes easy to infer the rear view, whereby the visibility is improved.

Since the outer peripheral surfaces 12a and 23a of the mule connector part 10 and the female connector part 20 are formed as a substantially circular circumferential surface, when the outer peripheral surfaces 12a and 23a are viewed even in any direction, the shape in appearance is almost the same. This embodiment is particularly effective for connector configurations in which the front orientation cannot be recognized only from the appearance of the out r peripheral surfaces 12a and 23a; however, the present embodiment may be applied to a configuration in which the shapes of the outer peripheral surfaces 12a and 23a vary in accordance with the viewing direction as a matter of course.

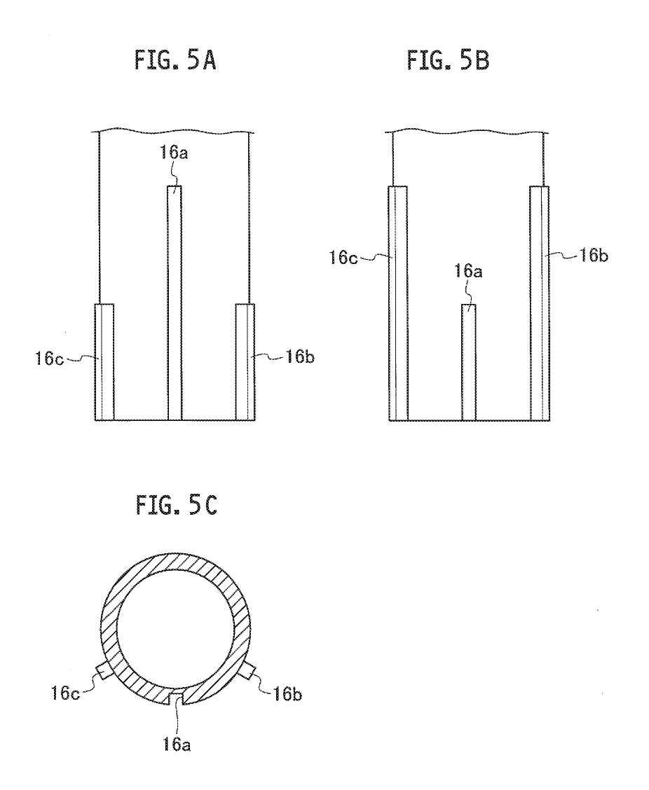

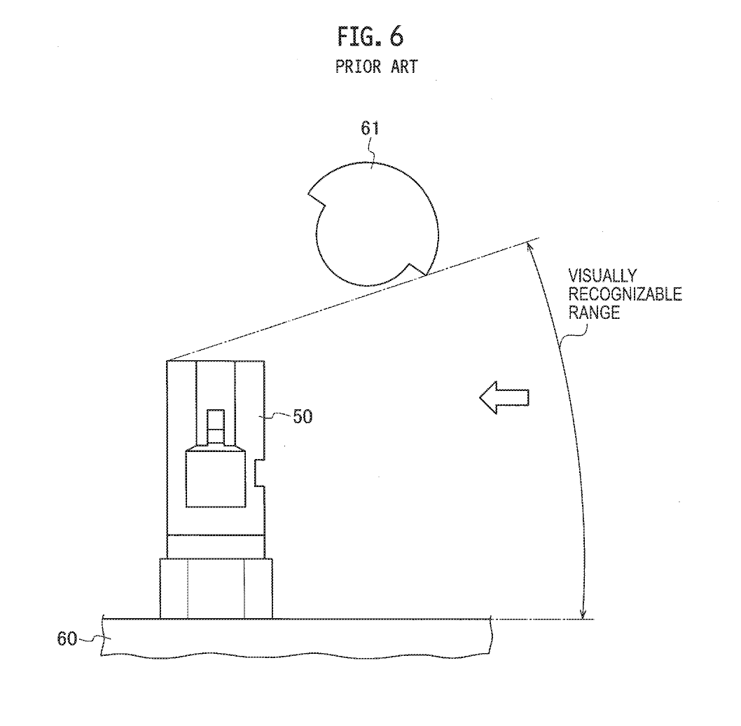

FIGS. 5A to 5C show modification examples of the front-alignment indicators. According to each of the modification examples, the male connector front-alignment indicators 16b and 16c on both sides are different from the male connector front-alignment indicator 16a at the center in the form. According to the first modification of FIG. 5A, the lengths of the front-alignment indicators 16b and 16c on both sides are formed to be shorter than the length of the front-alignment indicator 16a at the center in the front view. In the second modification of FIG. 5B, the length of the front-alignment indicator 16a at the center is formed to be shorter than the lengths of the front-alignment indicators 16b and 16c on both sides in the front view. In the third modification of FIG. 5C, the from-alignment indicators 16b and 16c on both sides are formed as protrusions, and the front-alignment indicator 16a at the center is formed as a groove in the front view. With this configuration, since recognition from the difference in the shapes is also added, the recognizability is further improved.

In the embodiment and modifications, the front-alignment indicators 16a, 16b, 16c, 26a, 26b and 26c are straight protrusions or grooves but may have shapes other than the straight shape, and also may have shapes other than protrusions and grooves. The front-alignment indicators 16a, 16b, 16c, 26a, 26b and 26c may have functions other than the recognition of the front orientation (e.g., guide ribs and the reinforcing ribs) in addition.

Although the embodiment of the present invention has been described heretofore, the embodiment is merely exemplified for facilitating the understanding of the present invention, and the present invention is not limited to the embodiment. The technical scope of the present invention may include not only the specific technical matters disclosed in the above-described embodiment but also various modifications, changes, and alternative techniques easily derived from the above-described specific technical matters.

What is claimed is:

1. A connector comprising:
a first connector part having a first terminal;
a second connector part being fitted to the first connector part in a prescribed fitting orientation and having a second terminal to be connected to the first terminal; and
a plurality of front-alignment indicators provided on an outer peripheral surface of at least one of the first connector part and the second connector part such that at least one of the plurality of front-alignment indicators is visible even when the outer peripheral surface is viewed from any rotational angle direction and appearances of the plurality of front-alignment indicators change when a rotational angle direction from which the outer peripheral surface is viewed changes, wherein
the plurality of front-alignment indicators are provided at three or more positions, and all of the front-alignment indicators are arranged in a region smaller than half the outer peripheral surface in a circumferential direction, and the front-alignment indicators located at both ends of the region in which the front-alignment indicators are arranged are protrusions.

2. The connector according to claim 1, wherein
the plurality of front-alignment indicators are provided on both outer peripheral surfaces of the first connector part and the second connector part and the plurality of front-alignment indicators provided on both outer peripheral surfaces of the first connector part and the second connector part are provided at same rotational positions with respect to a front orientation.

3. The connector according to claim 1, wherein
two front-alignment indicators located at both ends have protrusion heights such that both of the two front-alignment indicators are visible when viewed from a rotational angle direction opposite to a rotational angle direction from which all the front-alignment indicators can be seen to be located symmetrically.
